(19) United States
(12) Patent Application Publication
(10) Pub. No.: US 2023/0324510 A1
(43) Pub. Date: Oct. 12, 2023

(54) WEATHER RADAR LEVELNESS AUTOMATIC MEASURING SYSTEM

(71) Applicant: CHINA METEROLOGICAL ADMINSTRATION METEROLOGICAL OBSERVATION CENTER, Beijing (CN)

(72) Inventors: Xu HAN, Beijing (CN); Yubao CHEN, Beijing (CN)

(21) Appl. No.: 17/637,080

(22) PCT Filed: Dec. 16, 2021
(86) PCT No.: PCT/CN2021/138844

§ 371 Date: Feb. 22, 2022

(30) Foreign Application Priority Data
Dec. 7, 2020 (CN) 202023053154.7
Dec. 17, 2020 (CN) 202011497912.6

(51) Int. Cl. G01S 7/40; G01S 13/95; G01C 9/06

(52) U.S. Cl. CPC G01S 7/40; G01C 9/06; G01S 13/95

(57) ABSTRACT

The invention discloses a weather radar levelness automatic measuring system which comprises an on-duty device, an antenna pedestal levelness measuring device, a feed source levelness measuring device and a wireless communication module. The on-duty device is used to send an awakening signal at set time; the antenna pedestal levelness measuring device is used to start measuring the antenna pedestal levelness in different directions when the pitch angle is 0° according to the awaking signal; the feed source levelness measuring device is used to start receiving a radar sidelobe radiation signal according to the awaking signal and calculating the feed source levelness according to the radar sidelobe radiation signal; and the wireless communication module is used to send the antenna pedestal levelness and the feed source levelness in different azimuths to an upper computer for display.

### BACKGROUND OF THE INVENTION

### 1. Field of the Invention

The invention relates to the technical field of levelness measurement, and in particular to a weather radar levelness automatic measuring system.

### 2. Description of the Related Art

The basis of the weather radar’s high-precision measurement of meteorological targets is radar calibration, and the antenna pedestal levelness measurement is one of the weather radar calibration items. The weather radar pedestal levelness measurement has been a difficult task for a long time. The antenna aperture size is 4.3 m, and the antenna feed source height is more than ten meters. The calibration measurement requires horizontality measurement at eight positions of the antenna base: 45°, 90°, 135°, 180°, 225°, 270°, 315°, and 360°. During each measurement, the elevation angle is set to 0°, the antenna is rotated 45° to stop, and the worker climbs to a platform of more than ten meters to place a combined image level; after the combined image level is stabilized, the worker starts measuring, performs manual readings and conversions; after the measurement is completed, the worker climbs down the platform, removes the ladder, turns on the radar, and then rotates 45° to measure, and so on until 360°. Lifting the ladder frequently and climbing on the platform for measurement takes a long time, the process is cumbersome, and the labor intensity is high.

### SUMMARY OF THE INVENTION

Based on this, the purpose of the invention is to provide a weather radar levelness automatic measuring system to automatically measure the feed source levelness and the antenna pedestal levelness in different azimuths.

In order achieve the above purpose, the invention provides a weather radar levelness automatic measuring system, wherein the system comprises:
an on-duty device, which is used to send an awaking signal at a set time;
an antenna pedestal levelness measuring device, which is arranged on a rotating mechanism, is connected to the on-duty device, and is used to start measuring the antenna pedestal levelness at different azimuths when the pitch angle is 0° according to the awaking signal;
a feed source levelness measuring device, which is connected to the on-duty device, is used to start receiving radar sidelobe radiation signals according to the awaking signal, determine the amplitudes of the horizontal polarization component and the vertical polarization component according to the radar sidelobe radiation signals, calculate the amplitude ratio, and calculate the feed source levelness according to the amplitude ratio;
a wireless communication module, which is respectively connected to the antenna pedestal levelness measuring device, the feed source levelness measuring device and an upper computer, and is used to send the antenna pedestal levelness and the feed source levelness in different azimuths to the upper computer for display.

Optionally, the feed source levelness measuring device is a dual-polarization micro-strip antenna.

Optionally, the antenna pedestal levelness measuring device is a MEMS levelness sensor.

Optionally, the rotating mechanism comprises:
a weather radar azimuth turntable, which is used to drive the azimuth rotation of the weather radar;
an antenna pedestal, which is parallel to the antenna normal, is arranged on the weather radar azimuth turntable, and is used to control the weather radar to rotate and scan in the pitching direction;
the antenna pedestal levelness measuring device is arranged at the center of the weather radar pitch turntable.

Optionally, the system further comprises:

a shell, wherein the two side panels of the shell are organic glasses, one side panel is the radiation window of the feed source levelness measuring device, and the other side panel is the antenna window of the wireless communication module; the shell is used to place the antenna pedestal levelness measuring device, the feed source levelness measuring device, and the wireless communication module.

Optionally, the on-duty device is a clock calendar chip or a clock calendar chip integrated with an ARM single-chip microcomputer.

Optionally, the system further comprises a battery, which is connected to the clock calendar chip, and is used to provide power to the clock calendar chip.

Optionally, the system further comprises a stabilized voltage supply, which is connected to the clock calendar chip, the battery, the antenna pedestal levelness measuring device, and the feed source levelness measuring device, respectively, and is used to start work according to the awaking signal, stabilize the voltage output by the battery, and provide a stable voltage to the antenna pedestal levelness measuring device and the feed source levelness measuring device.

According to the specific embodiments provided by the invention, the invention has the following technical effects:

The invention realizes the automatic measurement of the feed source levelness and the antenna pedestal levelness in different azimuths by providing an antenna pedestal levelness measuring device and a feed source levelness measuring device, transmits the measuring results to the upper computer by a wireless transmission module for display, which realizes long-term automatic non-contact measurement of weather radar levelness, remote networked reading, unattended work, and overcomes the problems of long time spent in traditional measurement, cumbersome process and high labor intensity.

In addition, the invention sends an awaking signal at a set time by providing an on-duty device, and then detects the feed source levelness and the antenna pedestal levelness in different azimuths according to the awaking signal, and other times except the set time are in the sleep state, which realizes low power consumption.

### BRIEF DESCRIPTION OF THE DRAWINGS

In order to explain the embodiments of the invention or the technical solutions in the prior art more clearly, the drawings that need to be used in the embodiments will be briefly introduced hereinafter. Obviously, the drawings in the following description are only some embodiments of the invention. For those of ordinary skill in the art, other drawings can be obtained based on these drawings without creative work.

FIG. 1 is a schematic structural diagram of the weather radar levelness automatic measuring system according to the embodiment of the invention;

FIG. 2 is a schematic diagram of the installation of the antenna pedestal levelness measuring device according to the embodiment of the invention;

FIG. 3 is a structural diagram of the antenna pedestal levelness measuring device according to the embodiment of the invention;

FIG. 4 is a structural diagram for measuring the feed source levelness according to the embodiment of the invention;

FIGS. 5(a) (b) is a schematic diagram for measuring the dual-polarization weather radar feed source levelness according to the embodiment of the invention;

FIG. 6 is a schematic diagram of the shell according to the embodiment of the invention;

FIG. 7 is a layout diagram of the internal structure of the weather radar levelness automatic measuring system according to the embodiment of the invention.

In the figures, 1 refers to the on-duty device; 2 refers to the antenna pedestal levelness measuring device; 3 refers to the feed source levelness measuring device; 4 refers to the wireless communication module; 5 refers to the battery; 6 refers to the stabilized voltage supply.

### DETAILED DESCRIPTION OF THE PREFERRED EMBODIMENTS

The technical solutions in the embodiments of the invention will be clearly and completely described hereinafter with reference to the drawings in the embodiments of the invention. Obviously, the described embodiments are only a part of the embodiments of the invention, rather than all the embodiments. Based on the embodiments of the invention, all other embodiments obtained by those of ordinary skill in the art without creative efforts shall fall within the protection scope of the invention.

The purpose of the invention is to provide a weather radar levelness automatic measuring system to automatically measure the feed source levelness and the antenna pedestal levelness in different azimuths.

In order to make the above objectives, features and advantages of the invention more obvious and understandable, the invention will be further described in detail hereinafter with reference to the drawings and specific embodiments.

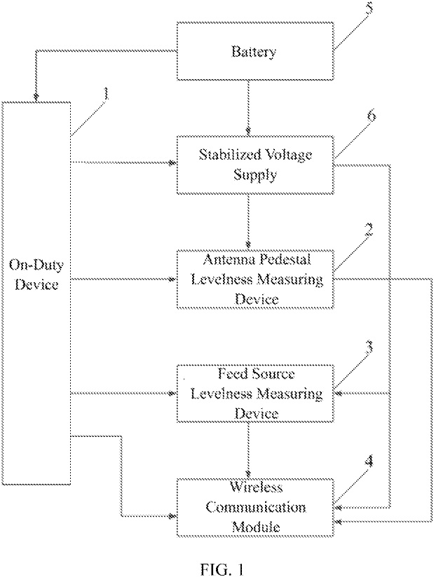

As shown in FIG. 1, the invention discloses a weather radar levelness automatic measuring system, wherein the system comprises: an on-duty device 1, an antenna pedestal levelness measuring device 2, a feed source levelness measuring device 3, and a wireless communication module 4; the antenna pedestal levelness measuring device 2 is arranged on a rotating mechanism; the antenna pedestal levelness measuring device 2 is connected to the on-duty device 1; the feed source levelness measuring device 3 is connected to the on-duty device 1; the wireless communication module 4 is respectively connected to the antenna pedestal levelness measuring device 2, the feed source levelness measuring device 3 and an upper computer.

The on-duty device 1 is used to send an awaking signal at a set time; the antenna pedestal levelness measuring device 2 is used to start measuring the antenna pedestal levelness at different azimuths when the pitch angle is 0° according to the awaking signal; the feed source levelness measuring device 3 is used to start receiving radar sidelobe radiation signals according to the awaking signal, determine the amplitudes of the horizontal polarization component and the vertical polarization component according to the radar sidelobe radiation signals, calculate the amplitude ratio, and calculate the feed source levelness according to the amplitude ratio; the wireless communication module 4 is used to send the antenna pedestal levelness and the feed source levelness in different azimuths to the upper computer for display.

The on-duty device 1 of the invention is used to automatically turn on at a set time and send an awaking signal, so that the antenna pedestal levelness measuring device 2 is used to measure the antenna pedestal levelness when the elevation angle of the weather radar is set to 0° and the azimuth angle is 45°, 90°, 135°, 180°, 225°, 270°, 315°, and 360° according to the awaking signal; the time for one revolution is 60 s; the on-duty device 1 of the invention is automatically turned on at a set time, and sleeps in the rest of the time, so as to realize an ultra-long standby. The on-duty device 1 in the invention may not only comprise a clock calendar chip, but also a clock calendar chip integrated with an ARM single-chip microcomputer.

The antenna pedestal levelness measuring device 2 of the invention is arranged on a rotating mechanism; the antenna pedestal levelness measuring device 2 is used to start measuring the antenna pedestal levelness at different azimuths when the pitch angle is 0° according to the awaking signal, that is, the weather radar levelness; the antenna pedestal levelness calibration test is one of the weather radar calibration test items to measure whether the weather radar levelness meets the index requirements when the pitch angle is 0° and is in a horizontal state.

The wireless communication module 4 in the invention is a ZigBee wireless communication module.

The upper computer is connected to the wireless communication module 4, and is used to judge whether the antenna pedestal levelness exceeds the set range; if it exceeds the set range, it will flash an alarm and display the azimuth and elevation angle of the weather radar so that the worker can adjust the antenna pedestal levelness according to the azimuth and elevation angle; if it does not exceed the set range, no processing is required. The upper computer is also used to determine whether the difference between the feed source levelness and the antenna pedestal levelness is greater than the set value; if the difference is greater than the set value, a flashing alarm will be used to guide the worker to fine-tune the feed source so that the feed source levelness is consistent with the antenna pedestal levelness.

The rotating mechanism of the invention comprises: a weather radar azimuth turntable and an antenna pedestal; the antenna pedestal is arranged on the weather radar azimuth turntable; the antenna pedestal levelness measuring device 2 is arranged at the center of the weather radar azimuth turntable. The weather radar azimuth turntable is used to drive the azimuth rotation of the weather radar. The antenna pedestal is used to control the weather radar to rotate and scan in the pitching direction. The antenna pedestal levelness measuring device 2 is arranged at the center of the antenna pedestal, and the weather radar levelness is determined by measuring the antenna pedestal levelness when the elevation angle is 0°.

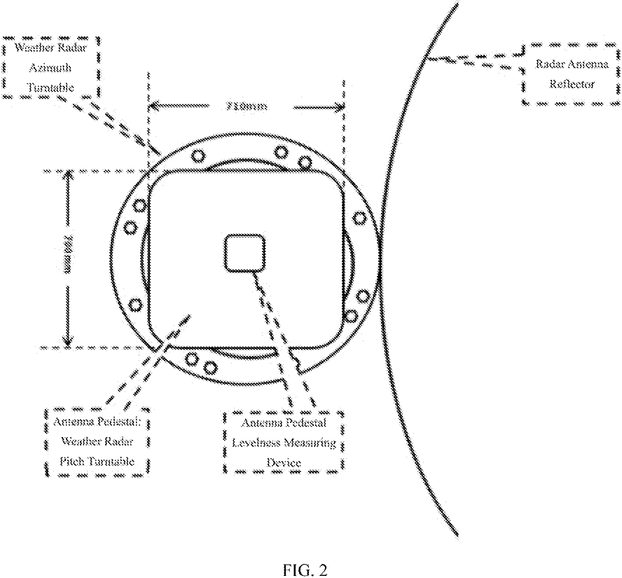

Specifically, as shown in FIG. 2, the right side is a partial section of the weather radar parabolic reflector, which is parabolic; the circular disc in the middle is the weather radar azimuth turntable, which controls the azimuth rotation of the weather radar; the big square in the middle is the weather radar pitch turntable, that is, the antenna pedestal, which controls the weather radar to rotate and scan in the pitching direction; the small square in the center is the antenna pedestal levelness measuring device 2, which is installed in the center of the square platform on the top of the pitch turntable. The antenna pedestal levelness measuring device 2 determines the weather radar levelness by measuring the levelness of the rotating mechanism at a pitch angle of 0°. The reflector is the main body of the weather radar, which forms an antenna beam by reflecting the radiation signal of the feed source at the focal point of the parabolic reflector to radiate electromagnetic waves into space.

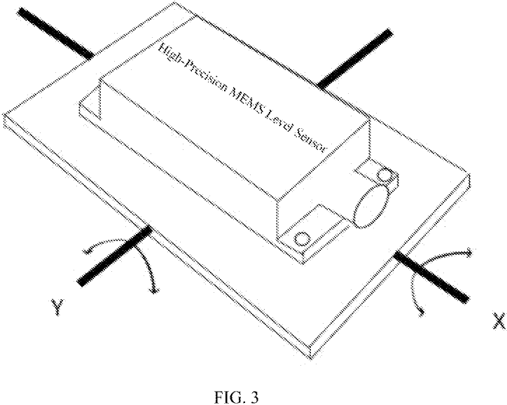

There are many methods for levelness measurement. The combined image level meter is the most widely used weather radar levelness measuring method. This type of levelness measuring device relies on bubble or water bubble change measurement, and the data needs to be read manually after the radar is stopped and stabilized, which is inconvenient to use. Therefore, the invention selects a high-precision MEMS level sensor as the antenna pedestal levelness measuring device 2. The full name of MEMS is Micro-Electro Mechanical System. As shown in FIG. 3, the high-precision MEMS levelness sensor uses MEMS technology and digital output to achieve levelness measurement. The sensor adopts high-resolution differential digital-to-analog conversion, built-in automatic compensation and filtering algorithms, to minimize errors caused by environmental changes, and accurately measure the inclination angle of the antenna base relative to the X and Y axes, with a measurement accuracy of 0.001°. The high-precision MEMS levelness sensor is a mature product, which is installed in the shell, and the high-precision MEMS levelness sensor is kept parallel to the plane of the measuring device base through processing and micro-adjustment.

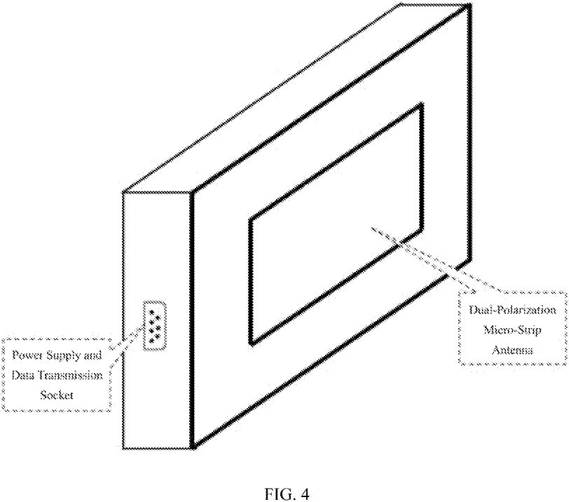

The feed source levelness measuring device 3 of the invention adopts a dual-polarization micro-strip antenna; as shown in FIG. 4, the dual polarization micro-strip antenna is installed perpendicular to the horizontal plane, the horizontal polarization direction of the dual polarization micro-strip antenna is parallel to the horizontal polarization direction of the feed source port surface, and the vertical polarization direction of the dual polarization micro-strip antenna is parallel to the vertical polarization direction of the radar antenna; the radar vertical polarization radiation signal measurement and horizontal polarization radiation signal measurement circuits are designed for polarization component testing. With the principle that the polarization direction of the sidelobe radiation signal of the radar antenna feed source is unchanged, the amplitude ratio is obtained by determining the ratio of the amplitude of the vertical polarization component to the amplitude of the horizontal polarization component by receiving the radar sidelobe radiation signal so as to calculate the feed source levelness according to the amplitude ratio.

The invention measures the vertical polarization signal amplitude and the horizontal polarization signal amplitude of the radar radiation signal through the dual polarization micro-strip antenna, calculates the amplitude ratio, and calculates the radar antenna feed source through the amplitude ratio, that is, the offset angle relative to the levelness measuring device, which is used to measure the dual-polarization weather radar antenna feed source levelness. At present, the weather radar antenna feed source levelness depends on the antenna pedestal levelness. The antenna feed source levelness and the antenna pedestal levelness have been calibrated before leaving the factory. The feed source levelness can be guaranteed by measuring the antenna pedestal levelness. Taking into account the deformation factors of the radar’s long-term operation, when the feed source levelness is out of tolerance, it will affect the measurement accuracy of parameters such as the differential reflectance factor of the dual-polarization radar.

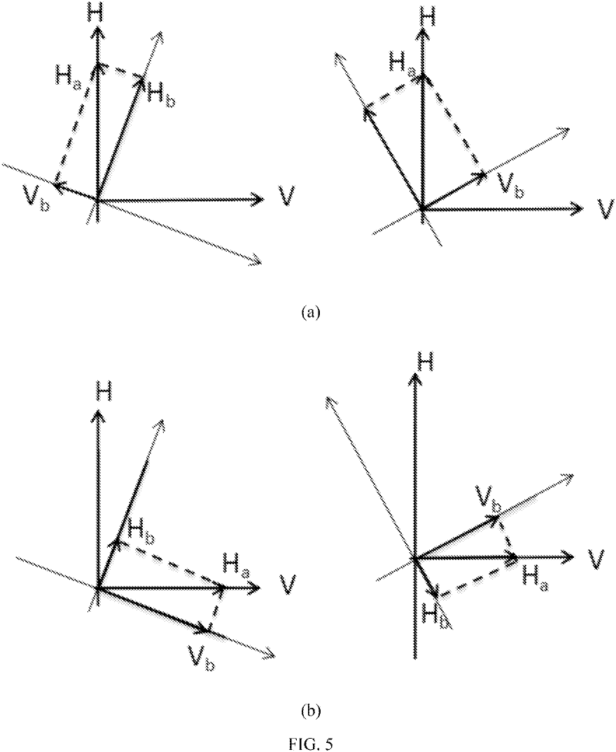

FIGS. 5(a) (b) is a schematic diagram for measuring the dual-polarization weather radar feed source levelness according to the embodiment of the invention; FIG. 5(a) shows that the vertically polarized wave Hₐ is emitted at the antenna feed source, and the antenna pedestal levelness measuring device 2 receives the vertically polarized wave Hₐ; if the polarization direction of the antenna pedestal levelness measuring device 2 is parallel to the polarization direction of the feed source, the vertical polarization component is Hₐ and the horizontal polarization component is “0”; if it is relative deviation, for example, the feed source levelness is right or left relative to the antenna pedestal levelness, then the horizontal polarization channel of the antenna pedestal levelness measuring device 2 outputs V_{b}, the vertical polarization channel outputs H_{b}, and the offset angle is:

$$θ = t {g}^{- 1} \frac{{V}_{3}}{{H}_{3}} ;$$

FIG. 5(b) shows that the horizontally polarized wave Vₐ is emitted at the antenna feed source, and the antenna pedestal levelness measuring device 2 receives the horizontally polarized wave Vₐ; if the polarization direction of the antenna pedestal levelness measuring device 2 is parallel to the polarization direction of the feed source, then the horizontal polarization component is Vₐ and the vertical polarization component is “0”; if the feed source levelness is right or left, then the horizontal polarization channel of the antenna pedestal levelness measuring device 2 outputs V_{b}, the vertical polarization channel outputs H_{b}, and the offset angle is:

$$θ = t {g}^{- 1} \frac{{H}_{3}}{{V}_{3}} ;$$

For vertical polarization single-polarization radar, the method shown in FIG. 5(a) is used to measure the offset angle; for horizontal polarization single-polarization radar, the method shown in FIG. 5(b) is used to measure the offset angle; for the vertical polarization and horizontal polarization dual-transmitting dual-receiving radar, the signal is received through the vertical polarization and horizontal polarization channels of the radar, and the calculation method is the same as above.

The system of the invention further comprises a battery 5 and a stabilized voltage supply 6; the battery 5 is connected to the clock calendar chip; the stabilized voltage supply 6 is connected to the clock calendar chip, the battery 5, the antenna pedestal levelness measuring device 2, and the feed source levelness measuring device 3, respectively; the battery 5 is used to provide power to the clock calendar chip and the stabilized voltage supply 6. The stabilized voltage supply 6 is used to start work according to the awaking signal, stabilize the voltage output by the battery 5, and provide a stable voltage to the antenna pedestal levelness measuring device 2 and the feed source levelness measuring device 3.

The battery 5 of the invention selects a lithium battery for high-efficiency power supply. The stabilized voltage supply 6 may be a conventional stabilized circuit. The battery 5 provides power to the clock calendar chip and the stabilized voltage supply 6 during operation, and the battery 5 only provides power to the clock calendar chip during the rest of the time, and wakes up during calibration and measurement once a month, and the power consumption in the working state is only in the milliwatt level. In addition, the invention adopts the low power consumption design of the antenna pedestal levelness measuring device 2 and the feed source levelness measuring device. After the measurement, the on-duty device 1 controls the stabilized voltage supply 6 to shut down, enters the sleeping state, and waits for the next wake-up. The battery capacity is designed without charging for three years to ensure one year of work.

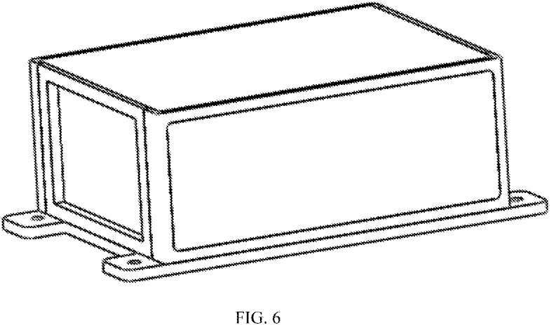

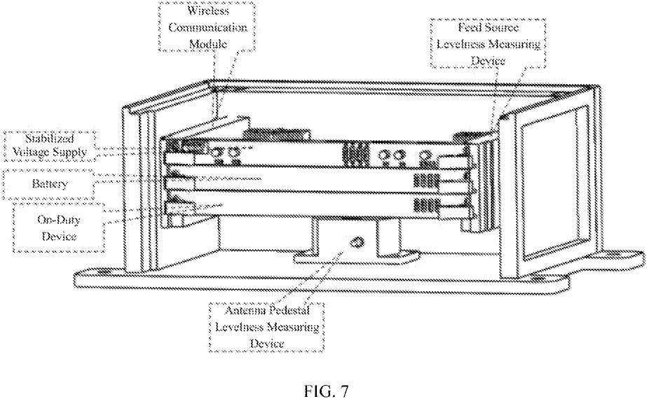

As shown in FIGS. 6-7, the two side panels of the shell are organic glasses, one side panel is the radiation window of the feed source levelness measuring device 3, and the other side panel is the antenna window of the wireless communication module 4; the shell is used to place the antenna pedestal levelness measuring device 2, the feed source levelness measuring device 3, and the wireless communication module 4; specifically, the feed source levelness measuring device 3 is located on the right side, and the antenna window on the right side plate is an organic glass plate, which transmits electromagnetic waves; the wireless communication module 4 is located on the left side, and the antenna window on the left side panel is an organic glass plate. Through the antenna, the feed source levelness measuring device 3 and the wireless communication module 4 are fixed on the side plate by screws. The antenna of the feed source levelness measuring device 3 is perpendicular to the bottom plate, the antenna horizontal polarization direction is parallel to the radar feed source horizontal plane, and the antenna vertical polarization direction is vertical to the radar feed source horizontal plane. A guiding groove is provided between the feed source levelness measuring device 3 and the wireless communication module 4, and the on-duty device 1, the stabilized voltage supply 6, and the battery 5 can be inserted therein. Behind the three devices is a motherboard to realize the connection between the three devices, and the antenna pedestal levelness measuring device 2 is installed on the bottom plate.

The technical solutions disclosed in the invention has the following advantageous:

1. The automatic measurement of weather radar levelness has been a difficult problem for a long time. At present, it is manually tested with a combined image level meter; the test process is complicated and it is difficult to test, which is one of the most physically demanding items in the calibration of radar stations. The invention realizes long-term automatic non-contact measurement of weather radar levelness by adopting a MEMS levelness measuring module, a dual-polarization feed source levelness measuring module, an ARM on-duty control module and a wireless communication module.

2. The purpose of measuring the weather radar antenna pedestal levelness is to ensure the antenna feed source levelness, and there is currently no antenna feed source levelness measuring device. The invention uses the dual- polarization antenna of the antenna feed source levelness measuring device to receive the radar feed radiation signal, and calculates the antenna feed source levelness by measuring the vertical polarization and the horizontal polarization amplitude ratio to achieve the purpose of automatically measuring the antenna feed source levelness. During long-term operation, the measurement of feed source levelness caused by feed deformation is always blank.

3. The invention proposes a clock calendar chip sleeping and awaking design, combined with a large-capacity battery, and through the ow power consumption design of the antenna pedestal levelness measuring device, the feed source levelness measuring device, and the wireless communication module, and a high-efficiency power supply design, the invention comprehensively reduces system power consumption and realizes long-term automatic non-contact measurement.

The various embodiments in this specification are described in a progressive manner, and each embodiment focuses on the differences from other embodiments, and the same or similar parts between the various embodiments can be referred to each other.

Specific embodiments are used in this article to illustrate the principle and implementation of the invention, and the description of the above embodiments is only used to help understand the method and core idea of the invention; at the same time, for those of ordinary skill in the art, according to the idea of the invention, there will be modifications in the specific implementation and the scope of invention. In summary, the content of this specification should not be construed as a limitation to the invention.

1. A weather radar levelness automatic measuring system, wherein the system comprises:
an on-duty device, which is used to send an awaking signal at a set time;
an antenna pedestal levelness measuring device, which is arranged on a rotating mechanism, is connected to the on-duty device, and is used to start measuring the antenna pedestal levelness at different azimuths when the pitch angle is 0° according to the awaking signal;
a feed source levelness measuring device, which is connected to the on-duty device, is used to start receiving radar sidelobe radiation signals according to the awaking signal, determine the amplitudes of the horizontal polarization component and the vertical polarization component according to the radar sidelobe radiation signals, calculate the amplitude ratio, and calculate the feed source levelness according to the amplitude ratio;
a wireless communication module, which is respectively connected to the antenna pedestal levelness measuring device, the feed source levelness measuring device and an upper computer, and is used to send the antenna pedestal levelness and the feed source levelness in different azimuths to the upper computer for display.

2. The weather radar levelness automatic measuring system according to claim 1, wherein the feed source levelness measuring device is a dual-polarization micro-strip antenna.

3. The weather radar levelness automatic measuring system according to claim 1, wherein the antenna pedestal levelness measuring device is a MEMS levelness sensor.

4. The weather radar levelness automatic measuring system according to claim 1, wherein the rotating mechanism comprises:
a weather radar azimuth turntable, which is used to drive the azimuth rotation of the weather radar;
an antenna pedestal, which is parallel to the antenna normal, is arranged on the weather radar azimuth turntable, and is used to control the weather radar to rotate and scan in the pitching direction;
the antenna pedestal levelness measuring device is arranged at the center of the weather radar pitch turntable.

5. The weather radar levelness automatic measuring system according to claim 1, wherein the system further comprises:
a shell, wherein the two side panels of the shell are organic glasses, one side panel is the radiation window of the feed source levelness measuring device, and the other side panel is the antenna window of the wireless communication module; the shell is used to place the antenna pedestal levelness measuring device, the feed source levelness measuring device, and the wireless communication module.

6. The weather radar levelness automatic measuring system according to claim 1, wherein the on-duty device is a clock calendar chip or a clock calendar chip integrated with an ARM single-chip microcomputer.

7. The weather radar levelness automatic measuring system according to claim 6, wherein the system further comprises a battery, which is connected to the clock calendar chip, and is used to provide power to the clock calendar chip.

8. The weather radar levelness automatic measuring system according to claim 7, wherein the system further comprises a stabilized voltage supply, which is connected to the clock calendar chip, the battery, the antenna pedestal levelness measuring device, and the feed source levelness measuring device, respectively, and is used to start work according to the awaking signal, stabilize the voltage output by the battery, and provide a stable voltage to the antenna pedestal levelness measuring device and the feed source levelness measuring device.
